(19) United States
(12) Patent Application Publication
(10) Pub. No.: US 2008/0228922 A1
(43) Pub. Date: Sep. 18, 2008

(54) System and Method for Providing Client Awareness in High-Availability Application Architecture

(75) Inventors: Bing-Hung Lin, Sindian City (TW); Jeffrey Liou, Hsin-Chu City (TW); Kuo-Rung Hsiao, Hsin-Chu City (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/686,167

(22) Filed: Mar. 14, 2007

(51) Int. Cl. G06F 15/16

(52) U.S. Cl. 709/227

(57) ABSTRACT

System and method for providing client awareness in a high-availability application architecture. One embodiment is a method of servicing a service request in a network maintained by an organization and comprising a plurality of servers. The method comprises responsive to an initial request for service by a client via a service broker, providing to the client through the service broker a response identifying an available one of the servers; and connecting the client directly to the available server, the client thereafter sending successive requests for service directly to the available server without involvement of the service broker.

### BACKGROUND

When a client accesses a network service via a layer 4 network switch, the switch shields the identity of the client from the server to which the client is connected. In particular, identifying information such as a user ID and a device ID are provided by the client to the layer 4 switch, which logs the user in using the information provided; however, in accordance with current network architecture standards, the switch provides its own device ID to the server. This situation can result in serious network security issues in cases in which, for example, the user may be an authorized user, but the device from which the user is accessing the server is not secure for some reason.

### BRIEF DESCRIPTION OF THE DRAWINGS

The features and advantages of a system and method for providing client awareness in a high-availability application network architecture in accordance with an embodiment will be more clearly understood from the following description taken in conjunction with the accompanying drawings in which like reference numerals designate similar or corresponding elements, regions, and portions, and in which:

FIG. 1 illustrates a system comprising a high-availability application architecture in which plurality of external and internal clients can connect to a private network.

FIG. 2 illustrates connection of a client to a private network 200 in accordance with one embodiment.

FIG. 3 illustrates implementation of a system comprising a client-awareness design for private network access in accordance with one embodiment.

FIG. 4 illustrates a flow diagram of an embodiment of a method for processing service requests in a system comprising a client-awareness design for private network access.

### DETAILED DESCRIPTION

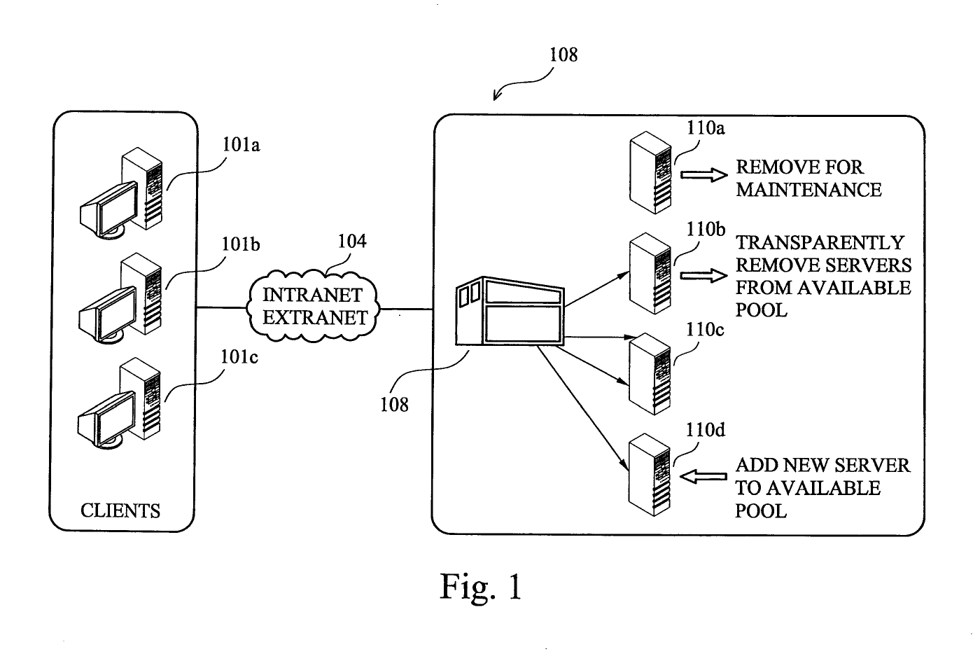

FIG. 1 illustrates a system 100 comprising a high-availability application architecture in which plurality of clients, represented by clients 101a-101c, may connect to a private network 102 via another network 104, which may be configured as an intranet or extranet. A layer 4 switch 108 performs IP translation and routing between clients 101a-101c and a plurality of network servers, represented in FIG. 1 by servers 110a-110d. In general, the layer 4 switch 108 provides load balancing across the servers 110a-110d based on individual session information and status. When one of the clients 101a-101c makes a request for an application running on the servers 110a-110d, the switch 108 determines which of the servers should handle the request. This determination may be based on current server loads, for example. Once one of the servers 110a-110d is selected to handle the request, the layer 4 switch 108 binds the session to the selected server.

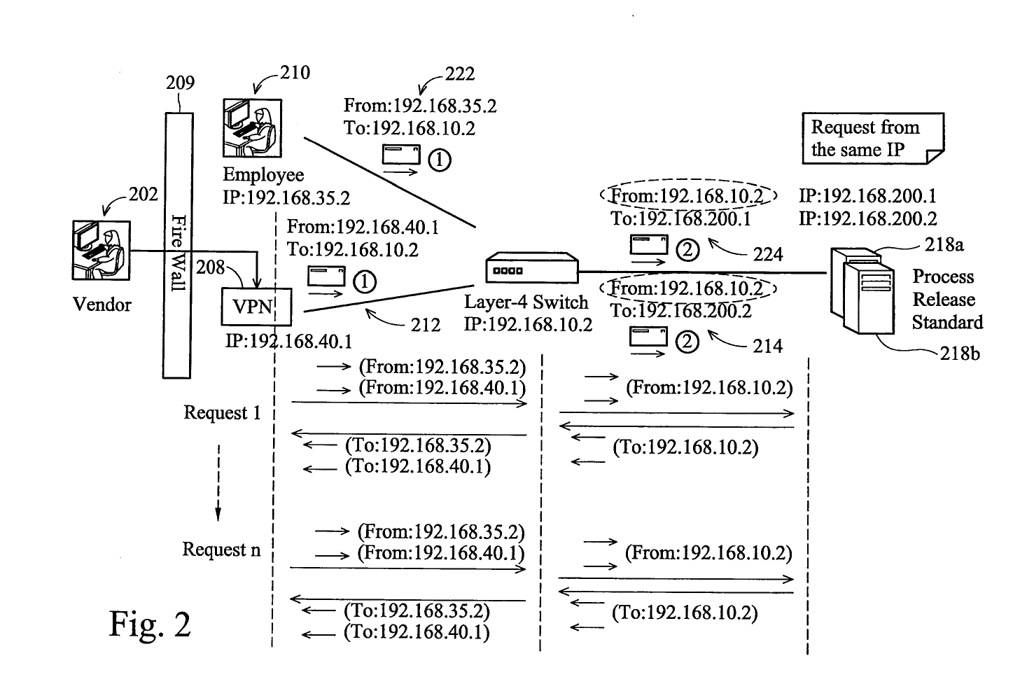

FIG. 2 illustrates connection of a client to a private network 200 in accordance with one embodiment. The client comprises an entity selected from a group consisting of an employee of the organization, a customer of the organization, and a vendor of the organization. As shown in FIG. 2, in a first scenario, a vendor at a client 202 connects to a layer 4 switch 204 via virtual private network (“VPN”) 208. A firewall 209 is optionally provided between the client 202 and the VPN 208 for additional security. In a second scenario, an employee at a client 210 connects directly to the layer 4 switch 204. Considering first the first scenario, an initial request 212, which is typically a login request, is made by the VPN 208 on behalf of the client 202. The request 212 is indicated as being from IP address 192.168.40.1, which is the IP address of the VPN 208, and to IP address 192.168.10.2, which is the IP address of the layer 4 switch 204. The layer 4 switch 204 selects one of a plurality of servers, represented in FIG. 2 by servers 218a, 218b, to handle the request 212 (e.g., the server 218b) and then sends a request 214 to the selected server. The request 214 is indicated as being from IP address 192.168.10.2, which is the IP address of the layer 4 switch 204, and to IP address 192.168.200.2, which is the IP address of the server 218b. All subsequent requests from the client 202 are handled in a similar manner. Accordingly, as is illustrated in FIG. 2, the server 218b remains unaware throughout the session that the requests it is processing originate from the client 202 via the VPN 208; from the point of view of the server 218b, the request originated from the layer 4 switch 204.

Turning now to the second scenario, an initial request 222, which will typically be a login request, is forwarded to the layer 4 switch 204 from the client 210. The request 222 is indicated as being from IP address 192.168.35.2, which is the IP address of the client 210, and to IP address 192.168.10.2, which is the IP address of the layer 4 switch 204. The layer 4 switch 204 selects one of the servers 218a, 218b, to handle the request 222 (e.g., the server 218a) and then sends a request 224 to the selected server. The request 224 is indicated as being from IP address 192.168.10.2, which is the IP address of the layer 4 switch 204, and to IP address 192.168.200.1, which is the IP address of the server 218a. All subsequent requests from the client 210 are handled in a similar manner. Accordingly, as is illustrated in FIG. 2, the server 218a remains unaware throughout the session that the requests it is processing originate from the client 210; from the point of view of the server 218a, the request originated from the layer 4 switch 204. Clearly, this situation poses a security risk to private network 200.

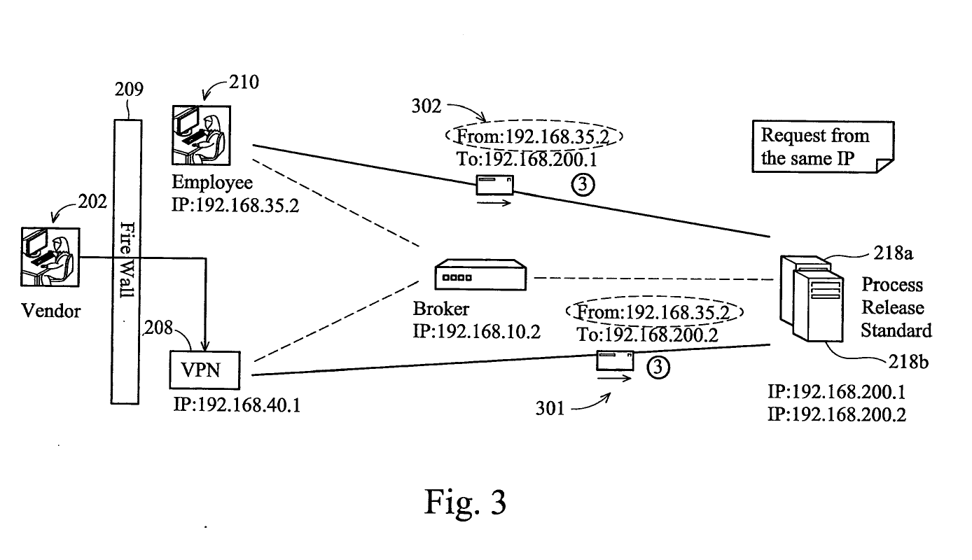

FIG. 3 illustrates implementation of a client-awareness design for private network access in accordance with one embodiment. The embodiment shown in FIG. 3 is similar in all respects to that shown in FIG. 2, except that the layer 4 switch 204 has been replaced with a broker 300. The broker 300 may comprise a layer 4 switch or may comprise another device for implementing the methods described herein. Referring again to the first scenario described with reference to FIG. 2, after the initial requests 212, 214, are made and the user has been logged in, subsequent requests, represented in FIG. 3 by a request 301, from the client 202 via the VPN 208 are made directly from the VPN to the server 218b, bypassing the broker 300; hence, a direct connection is provided between the VPN 208 and the server 218b. The request 301 is indicated as being from IP address 192.168.40.1, which is the IP address of the VPN 208, and to the IP address 192.168.200.2, which is the IP address of the server 218b. As a result, because the server 218b is aware of the origin of the request, the server is able to apply appropriate security measures based on the identity of the originator.

Referring now to the second scenario described with reference to FIG. 2, after the initial requests 222, 224, are made and the user is logged in, subsequent requests, represented in FIG. 3 by a request 302, from the client 210 are made directly from the client to the server 218a, bypassing the broker 300. The request 302 is indicated as being from IP address 192.168.35.2, which is the IP address of the client 210, to the IP address 192.168.200.1, which is the IP address of the server 218a; hence, a direct connection is provided between the VPN 208 and the server 218a. As a result, because the server 218a is aware of the origin of the request, the server is able to apply appropriate security measures based on the identity of the originator.

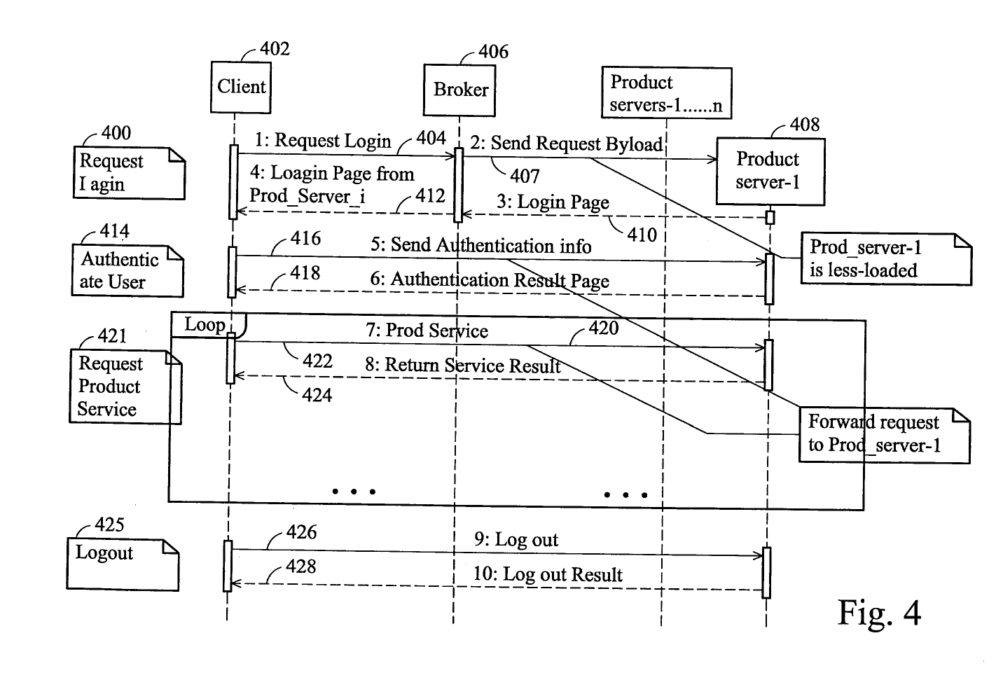

FIG. 4 illustrates a flow diagram of one embodiment of a method for processing service requests in a system comprising a client-awareness design for private network access. As shown in FIG. 4, a Request Login procedure 400 is initiated by a client 402 sending a RequestLogin message 404 to a broker 406, such as a layer 4 switch. In response to receipt of the RequestLogin message 404, the broker 406 sends a SendRequestByLoad message 407 to a server 408 selected from a plurality of servers. The selection of the server 408 is performed in a conventional manner, e.g., based on load balancing considerations. The server 408 returns a LoginPage message 410 to the broker 406, which in turn sends a LoginPage from Prod_Server_i message 412 to the client 400. The LoginPage from Prod_Server_i identifies to the client 400 which one of the plurality of servers will be handling the client request. In the illustrated embodiment “Prod_Server_i identifies the server 408.

Once the Request Login procedure 400 has been completed, as described above, an Authenticate User procedure 414 is initiated. In particular, the client 400 sends a SendAuthenticationInfo message 416 directly to the product server 408. The product server 408 returns an AutenticationResultPage message 418 to the client 400. After the Authenticate User procedure 414 has been completed, a Request Product Service procedure 421 is initiated. The client 400 sends a ProdService message 422 to the product server 408, which returns to the client 400 a ReturnServiceResult message 424. This process continues to until service is complete. Thereafter, a Logout procedure 425 is implemented, in which the client 400 sends to the product server 408 Logout message 426. The product server 408 returns a LogoutResult message 428 to the client 400, thereby logging the user out.

As is clearly illustrated in FIG. 4, all communication between the client 400 and the product server 408 subsequent to completion of the Request Login procedure 400 is carried out without the involvement of the broker 406. In this manner, the product server 408 remains aware of the identity of the client 400, as well as the user, throughout the session.

In an alternative embodiment, at some point during communication therewith, the selected server (e.g., product server 408) requests a second available server and, once such a second available server is identified, the process described above with reference to FIG. 4 is performed with respect to the second available server and the client, such that the client is connected directly to the second available server.

One embodiment is a method of servicing a service request in a network maintained by an organization and comprising a plurality of servers. The method comprises responsive to an initial request for service by a client via a service broker, providing to the client through the service broker a response identifying an available one of the servers; and connecting the client directly to the available server, the client thereafter sending successive requests for service directly to the available server without involvement of the service broker.

Another embodiment is a system for servicing a service request in a network maintained by an organization and comprising a plurality of servers. The system comprises means responsive to an initial request for service by a client via a service broker for providing to the client through the service broker a response identifying an available one of the servers; and means for connecting the client directly to the available server, the client thereafter sending successive requests for service directly to the available server without involvement of the service broker.

Yet another embodiment is a system for servicing a service request in a network maintained by an organization and comprising a plurality of servers. The system comprises at least one client for making an initial request for service; a service broker connected between the at least one client and the servers. The service broker receives the initial request; forwards the initial request to an available one of the servers; and, subsequent to the forwarding, directly connects the client to the available server such that subsequent requests are forwarded directly to the available server without involvement of the service broker.

While the preceding description shows and describes one or more embodiments, it will be understood by those skilled in the art that various changes in form and detail may be made therein without departing from the spirit and scope of the present disclosure. Therefore, the claims should be interpreted in a broad manner, consistent with the present disclosure.

What is claimed is:

1. A method of servicing a service request in a network maintained by an organization and comprising a plurality of servers, the method comprising:
responsive to an initial request for service by a client via a service broker, providing to the client through the service broker a response identifying an available one of the servers; and
connecting the client directly to the available server, the client thereafter sending successive requests for service directly to the available server without involvement of the service broker.

2. The method of claim 1 wherein the initial request comprises a login request.

3. The method of claim 1 wherein the service broker comprises a layer 4 switch.

4. The method of claim 1 wherein the client comprises an entity selected from a group consisting of an employee of the organization, a customer of the organization, and a vendor of the organization.

5. The method of claim 1 wherein the connecting is performed via a virtual private network.

6. The method of claim 1 wherein the connecting is performed through a firewall.

7. The method of claim 1 further comprising:
the available server requesting a second available server;
responding to the client with the second available server; and
connecting the client directly to the second available server.

8. A system for servicing a service request in a network maintained by an organization and comprising a plurality of servers, the system comprising:
means responsive to an initial request for service by a client via a service broker for providing to the client through the service broker a response identifying an available one of the servers; and
means for connecting the client directly to the available server, the client thereafter sending successive requests for service directly to the available server without involvement of the service broker.

9. The system of claim 8 wherein the initial request comprises a login request.

10. The system of claim 8 wherein the service broker comprises a layer 4 switch.

11. The system of claim 8 wherein the client comprises an entity selected from a group consisting of an employee of the organization, a customer of the organization, and a vendor of the organization.

12. The system of claim 8 wherein the connecting is performed via a virtual private network.

13. The system of claim 8 wherein the connecting is performed through a firewall.

14. The system of claim 8 further comprising:
the available server requesting a second available server;
responding to the client with the second available server; and
connecting the client directly to the second available server.

15. A system for servicing a service request in a network maintained by an organization and comprising a plurality of servers, the system comprising:
at least one client for making an initial request for service;
a service broker connected between the at least one client and the servers, the service broker for:
receiving the initial request;
forwarding the initial request to an available one of the servers; and
subsequent to the forwarding, directly connecting the client to the available server such that subsequent requests are forwarded directly to the available server without involvement of the service broker.

16. The system of claim 15 wherein the initial request comprises a login request.

17. The system of claim 15 wherein the service broker comprises a layer 4 switch.

18. The system of claim 15 wherein the client comprises an entity selected from a group consisting of an employee of the organization, a customer of the organization, and a vendor of the organization.

19. The system of claim 15 wherein the connecting is performed via a virtual private network.

20. The system of claim 15 wherein the connecting is performed through a firewall.
